(19) United States
(12) Patent Application Publication
(10) Pub. No.: US 2012/0008880 A1
(43) Pub. Date: Jan. 12, 2012

(54) ISOLATION SYSTEM FOR A MOBILE COMPUTING DEVICE

(76) Inventor: Landy Toth, Newtown, PA (US)

(21) Appl. No.: 13/177,182

(22) Filed: Jul. 6, 2011

Related U.S. Application Data
(60) Provisional application No. 61/361,908, filed on Jul. 6, 2010.

(51) Int. Cl. B65D 33/16; A45C 11/00; B65B 3/04; B23P 11/00

(52) U.S. Cl. 383/42; 29/426.4; 53/469

(57) ABSTRACT

An isolation system for isolating a mobile computing device from an environment while retaining the functionality of the mobile computing device that includes at least one sheet and a sealable region. The sheet may include one or more layer to maintain functionality of the enclosed mobile computing device during use. The isolation system may include a sterilizable outer surface for rendering an enclosed mobile computing device usable in a surgical environment. The isolation system may include a pump and channels or valves to allow for fluid removal or addition to the interior of the isolation system. The sheet of the isolation system may further comprise microtextured inner layer so as to maintain functionality of the enclosed mobile computing device in an aqueous environment or in a soiled condition.

### CROSS-REFERENCE TO RELATED APPLICATIONS

This application claims priority to U.S. Provisional Application No. 61/361,908, filed Jul. 6, 2010, which is herein incorporated by reference.

### BACKGROUND OF THE INVENTION

1. Field of the Invention

The present invention pertains to a system for protecting a mobile computing device. The invention is particularly useful for protecting a mobile computing device during use in a hostile or remote environment where damage to the device is quite possible. The invention is further useful for rendering a mobile computing device suitable for use in a sterile or surgical environment. The invention is also useful for general application in public environments across multiple users, where the spread of disease or bacteria is a major concern. The invention is especially, but not exclusively, useful for ruggedizing a mobile computing device for use by children, particularly in relatively uncontrolled learning environments.

2. Prior Art

Mobile computing devices such as tablet computers, smart phones, e-readers, and the like are becoming ubiquitous in daily life. These devices provide the user with convenience of accessing and/or storing information as well as interacting with others. Device battery life is becoming dramatically extended compared to previous generations of devices. The advent of touch displays and sophisticated user interfaces have further simplified device use. In addition, advances in microelectronics and interconnect technologies have continued to drive device size reduction, while increasing available computational power and peripheral capabilities (such as accelerometers, gyroscopes, temperature sensors, compasses, cameras, altimeters, etc.). Furthermore, reduced power profiles in such devices have essentially eliminated the need for forced convection cooling. All of these factors are enabling a vast range of new uses and opportunities for mobile computing devices.

In particular, there is strong motivation and demand to use such devices in harsh, highly restricted and/or remote environments. In addition, there is becoming a strong realization that such devices can be useful as real-time interfaces for cloud sourced personal consultation and trouble shooting applications in uncontrolled environments.

Such environments include, surgical arenas, hospital use, doctors offices, military arenas, field operations, construction sites, resorts, water parks, research laboratories, manufacturing sites, at sporting events, public offices, multiuser environments, in washrooms, beaches, public pools, in the wilderness, in a garage, kitchens, weddings, in the rain, and generally in uncontrolled environments.

In addition, the devices are appealing for use as learning tools and entertainment systems for children. Yet, children can be some of the most demanding and dangerous users for such devices. Damage due to contamination, cosmetic scratches, impacts, fluid ingress, plugged connectors, and paint marks are very real issues in these types of applications.

In many cases, touch enabled devices themselves become a breeding ground for bacteria. Furthermore, the presences of body oils on the device can attract dust and other contaminants from the surroundings as well as provide environments in which bacteria can flourish. This issue can be particularly dangerous to users of touch devices in public and hospital environments where surface contamination on a device can easily spread disease between users.

Cases and holsters for mobile computing devices exist on the market. They are generally open configurations with a range of extra pockets and flaps. They are also available in a range of sleek appealing designs. Yet, available cases do not isolate the mobile computing device from the surrounding environment.

There is a need to isolate a mobile computing device from a surrounding environment, while providing a user with the same functionality and interface that they have come to expect from such devices.

There is also a need to provide an easy, effective and low cost method for sterilizing a reusable mobile computing device while still maintaining the touch functionality and screen clarity thereof. Furthermore there is a need to provide isolation for a mobile computing device that can be sterilized without compromising utility of the device.

There is also a need to hermetically seal mobile computing devices thus providing effective isolation between the mobile computing device and a surrounding environment.

Furthermore, in aqueous applications, there is a need to isolate a mobile computing device from the surroundings while also rendering it buoyant in an aqueous environment.

### SUMMARY OF THE INVENTION

The invention provides a method for isolating a mobile computing device from a surrounding environment or user. The method includes inserting a mobile computing device into a sealable pouch and sealing the pouch.

By mobile computing device is meant a portable device such as a tablet computer, portable media player, e-reader, smart phone or the like, often comprising a touch screen or touch functionality and a display. One example is an iPhone and another example is an iPad, both produced by Apple Computer Inc. Other examples include Android compatible devices such as the HTC Droid Incredible smart phone, the HTC EVO 4G smart phone, RIM Blackberry devices, Palm Pre Plus. Some exemplary examples of e-readers include the Amazon Kindle, Barnes & Nobel Nook, and the Sony reader. Some examples of portable media players include the Apple iPod, Microsoft Zune, and Sandisk Sanso among others. There are many more tablets, portable media players, smart phones and e-readers on the market and further examples are available from public sources. In general mobile computing devices as described herein conform to approximately a flat rectangular shape, although some, such as the RIM Blackberry have a more contoured shape, it is understood that the invention pertains to isolation to variously shaped devices as well as rectangular devices. It is also understood that many devices have deployable keyboards and that such devices can be isolated with a retracted or deployed keyboard. In the case of a retracted keyboard, it is possible that only touch functionality can be used while the mobile computing device is isolated. In the case of a deployed keyboard, the keyboard functionality may be maintained while the mobile computing device is encapsulated.

Another aspect of the invention provides a method for preparing a device for use in a sterile environment. The method comprises a step of inserting a mobile computing device into a sealable pouch, sealing the pouch, inserting the pouch into a sterilization bag and sterilizing the result.

A further aspect of the invention provides an isolation system for isolating a mobile computing device from an environment. The isolation system may have a sheet, a sealable region, a pre-sealed region, where the sheet may be generally arranged into the shape of a pouch. The pouch is generally shaped so as to form fit around a mobile computing device. The sealable region is generally arranged at the opening of the pouch, although it may be located elsewhere on the isolation system.

The isolation system may have at least one sheet, wherein the sheet may be formed from a single material layer, or may be formed from multiple layers. The sheet may be equivalently a film, a nonwoven, a membrane, a coverlayer, an overlay, or the like. The sheet may be generally arranged to form a pouch, the pouch arranged so as to have an inside surface, an outside surface, and an opening, the opening often being arranged near an end of the pouch. The pouch may be shaped so as to accept a mobile computing device and may be shaped so as to form fit to a mobile computing device. The isolation system may further comprise at least one sealable region in connection with or as an extension of the sheet, situated near the open end of the pouch, whereby the sealable region may be arranged to form a barrier between the inside surface and outside surface of the pouch when sealed.

In an alternative embodiment, the sealable region may be comprised of a heat sealable material. In another embodiment, the sealable region comprises an adhesive layer.

One or more layers of the sheet, often a layer arranged towards the inside of the pouch, may be formed from a heat sealable material.

One or more layers of the sheet, often an outer or outermost layer arranged towards the outside of the pouch, may be formed from or treated with an oleophobic material. Oleophobic materials include long chain alcohols, silicones, fluorinated, hydrophobic, poly-hedral oligomeric silsesquioxane molecules with a moderately hydrophilic polymer such as polymethyl methacrylate (PMMA), FTFE and combinations thereof. Generally, such hydrophobic materials are textured with characteristic length scales over several orders of magnitude to produce super hydrophobic and/or super oleophobic surfaces.

One or more layers of the sheet, preferably an outer or outermost layer of the sheet may be formed from a scratch or abrasion resistant material. This layer is generally suitable for extending the use of the isolation system and preventing marring of the sheet during usage.

One or more layers of the sheet, preferably an outermost layer of the sheet may be formed from a salt water resistant material. Such a layer can be particularly useful on a beach or boat.

One or more layers of the sheet, preferably an outermost layer of the sheet may be formed from an antireflective or antiglare material. Such a layer is very useful in an outdoor environment.

One or more layers of the sheet may be formed from a rubber-like material.

In yet another embodiment, one or more layers of the sheet may be formed from an optically functional material selected from on or more of a polarized sheet, a lenticularly oriented sheet, a dithering sheet, a shaded sheet, or a UV blocking sheet.

One or more layers of the sheet, preferably an inner or innermost layer of the sheet may be formed by a heat sealable material.

One or more layers of the sheet, preferably an outer or outermost layer of the sheet may be a sterilizable material such as polypropylene, polymethylpentene, polypropylene copolymer, TEFZEL ETFE, TEFLON FEP, and PFA, polyolefins, polyesters, polyacrylates, polyalkylacrylates, peek, polyamide, polyacetals, as well as polycarbonate, and combinations thereof.

In another embodiment, the isolation system may have an air filled layer of a sheet, whereby the air filled layer is comprised of bubbles, laminates, foams, or irregular regions encasing trapped air. The air filled layer may provide both protection for the device from unexpected impacts, while also rendering the isolation system and an enclosed mobile computing device, buoyant in an aqueous environment.

The sealable region may be arranged so as to provide an airtight seal once the sealable region is sealed. The sealable region may be sealed by the application one or more of heat, pressure, light, or moisture.

The isolation system may be rendered capable of supporting an internal vacuum. In this case, the isolation system may be made air tight by sealing the sealable region whereby the sealable region and pre-sealed region(s) are intimately connected. In this sense, the isolation system may be formed from a sheet with low vapor permeability such as PVDF, polyamide 6, PET, PET and polyolefin laminates (such as ethylene vinyl acetate copolymer and polyester laminates) and combinations thereof. Further improvements in barrier properties can be achieved by incorporating ceramic layers and/or particulates (such as alumina) in conjunction with or in addition to the base polymer or an additional polymer/particulate composite.

The isolation system may be rendered pressurizable. In this case the isolation system may be made air tight by sealing the sealable region, so that a positive pressure can be established internally. Pressurization after sealing of the system can be used to improve buoyancy and to improve acoustic performance of the enclosed mobile computing device.

The isolation system may have raised protrusions located along the inner surface so as to form channels and cavities when placed tightly against an enclosed mobile computing device to enhance the audible performance of the overall device. In this embodiment, the channels and cavities form a volume of air between an enclosed mobile computing device and the isolation system. The volume of air acts as a buffer for the existing speaker system of the mobile computing device. In addition, when combined with vacuum or pressurized operation, these regions can be used to create resonant cavities within the device, acting as filters for audible waves. Furthermore, the sheet(s) of the isolation system may be placed under tension, and generally forming regions of concave or convex curvatures between protrusions. These structures can be used to further enhance and filter audio output from the enclosed mobile computing device. Additionally, these convex and concave regions of the isolation system can be substantially larger in area than the usual output port from the speaker of the mobile computing device, thus the isolation system can be used to extend the bass output from the mobile computing device while effectively isolating the device from the surroundings.

The isolation system may have textures or bumps along the internal surface of the sheet or pouch so as to form an internal air-gap or separation between an enclosed mobile computing device and at least one sheet of the isolation system, so as to maintain touch functionality in electrically conducting aqueous environments. In this aspect, the separations may prevent the aqueous fluid from coming into immediate contact with the touch screen of an enclosed mobile computing device, yet such separations may locally collapse under additional applied pressure from the user, thus enabling touch functionality in an aqueous environment. Such textured sheets may also be useful in maintaining touch functionality in environments where aqueous fluids such as blood, foods and other electric and/or ion conducting media may come into contact with the isolation system. Thus, even when soiled the user may continue to use the enclosed mobile computing device.

The isolation system may further have a deformed, possibly thermoformed, region situated near the speaker of an enclosed mobile computing device. Thus a dome shaped cavity may be arranged so as to protrude from the speaker of an enclosed mobile computing device and thus enhance the audible performance of the overall device.

In another aspect of the invention, suitable for use in sterile environments, the isolation system may comprise a sterilizable outer layer. Typical sterilization methods may include steam, E-beam, ethylene oxide (EtO), ozone, chemical disinfectants, among others. Some sterilizable materials may include polypropylene, polymethylpentene, polypropylene copolymer, TEFZEL ETFE, TEFLON FEP, and PFA, as well as polycarbonate, etc.

In yet another embodiment, suitable for use in sterile surgical environments, the isolation system may have a puncture resistant outer layer. The puncture resistant outer layer may also be sterilizable. Puncture resistance can be provided by an additional layer of a tough yet transparent polymer, such as polyurethane, silicone, styrene isoprene block copolymer or terpolymer or the like.

In yet another embodiment, also suitable for use in sterile environments, the isolation system may have a bioresistant outer surface to prevent bacterial adhesion and growth there upon. Bioresistant materials generally show low bioactivity. In one embodiment, the bioresistant outer surface may be formed from a self-assembled monolayer of phosphate, such as Orthobond available from Orthobond Corporation. Other bioresistant materials that may be suitable include thin continuous or broken layers of titanium, nickel alloys, and PEEK or combinations thereof. Furthermore, transparent bioresistant materials may be formed from a polymer that contains an antimicrobial, bioresistant and fungal resistant moiety that is linked into the backbone of the polymer. Some suitable moieties may include a bromine atom and a nitro group linked to one or more of the carbon atoms forming the backbone of the polymer.

Alternatively, in an aspect of the invention suitable for use in sterile and/or public environments, the outer surface of the isolation system is provided with an antibacterial coating.

The sheet of the isolation system may be optically transparent thus maintaining the visual acuity of the screen of the mobile computing device while providing isolation from the surroundings.

The isolation system, and particularly a sheet of the isolation system, may be equipped with a textured optical and optionally multilayered filter. The optical filter may be a polarizer for reducing glare for the user. The optical filter may be a molded layer or multilayer arranged over the viewable area of an enclosed mobile computing device so as to reduce the viewing angle, to less than 30 Deg, less than 20 Deg or less than 10 Deg.

The sheet of the isolation system may be made from an electrically isolating material. In this embodiment, the sheet may be less than 150 um thick, less than 100 um thick, or less than 50 um thick. Thus the isolation system can provide adequate isolation from the environment without compromising touch functionality of the mobile computing device. In some embodiments, to better maintain touch functionality of an enclosed mobile computing device, it may be beneficial for the sheet to have a dielectric permittivity of less than 20, less than 5 or less than 3.

The isolation system may have a chemically resistant outermost layer. The chemically resistant outermost layer may protect an enclosed mobile computing device from chemicals including solvents, acids and/or bases. In another embodiment, the isolation system may protect an enclosed mobile computing device from other chemicals such as organic compounds, and/or inorganic compounds.

Alternatively, the isolation system may have a washable outermost layer. The washable outermost layer may be scratch and chemical resistant, such as biaxially oriented polyester or a scratch resistant coating.

In one embodiment, the isolation system may be a single use disposable to provide temporary isolation to an enclosed mobile computing device. In this embodiment, the isolation system may have a low cost disposable sheet such as polystyrene. In an alternative embodiment, the sheet may be formed from a biodegradable polymer such as polyhydroxyalkanoate (PHA) biopolymer or Polylactic acid (PLA). Alternatively, the sheet may contain an additive such as EcoPure from Bio-Tec and ENA from BioGreen Products Co. Such additives attract microbes to the molecular structure of the material by allowing the hydrocarbons to be sensed once again by microbial colonies, thus rendering a conventional polymer sheet somewhat biodegradable.

In yet another embodiment, suitable for use in public environments, where a user may prefer private access to the mobile computing device, the isolation system may include a privacy shade. The privacy shade may be a layer having an optical filter that reduces the viewing angle of the screen of the mobile computing device. Alternatively, the privacy shade may include an additional optical filter such as a polarizer, a UV filter, or the like.

In another embodiment, the isolation system may have unique and/or decorative graphics so as to function as a stylized skin for an enclosed mobile computing device.

In a stylized embodiment, the isolation system may have a transparent sheet located where the viewable area of an enclosed mobile computing device would be and an opaque sheet elsewhere.

In alternative embodiment, suitable for use in a garage, machine shop, or uncontrolled manufacturing environment, the protective system may isolate the device from chemicals common to such environments such as hydrocarbons and oil. In this case the sheet may be formed from a protective material such as an acrylic, PEEK, PVDF, nitrile, neoprene, nylon or combinations thereof.

In yet another embodiment, the isolation system may include a heat sealable layer.

In another embodiment, the isolation system may include a scratch and/or abrasion resistant outer layer.

In yet another embodiment, the isolation system may include a lubricious inner layer so as to prevent stiction to an enclosed mobile computing device. The lubricious inner layer may be a fluoropolymer such as polytetrafluoroethylene (PTFE), perfluoroalkoxy polymer resin (PFA), fluorinated ethylene-propylene (FEP), polyethylenetetrafluoroethylene (ETFE), polyvinylfluoride (PVF), polyethylenechlorotrifluoroethylene (ECTFE), polyvinylidene fluoride (PVDF), polychlorotrifluoroethylene (PCTFE), perfluoropolyether (PFPE), and Nafion amongst others.

The sealable region may have an adhesive sealable tab or a re-sealable tab. In this instance the adhesive sealable tab or re-sealable tab may be formed from a pressure sensitive adhesive such as an acrylic adhesive or silicone gel adhesive.

The isolation system may further have a mechanically interlocking re-sealable tab. A mechanically interlocking re-sealable tab may include interlocking teeth, ribs, nodules or the like.

The isolation system may comprise a tear-able pull tab that can be broken for rapid and clean removal from an enclosed mobile computing device.

The isolation system may comprise one or more pairs of tear away tabs, the tear away tabs being an extension of at least one sheet or attached thereto, the tear away tabs arranged along an edge of the pouch, whereby the tear away tabs can be forcefully separated to open the isolation system and retrieve an internally held mobile computing device.

The isolation system may have an embossed region oriented on the interior surface of the pouch, whereby the embossed region would form a gap over the speaker port of an internally held mobile computing device.

The isolation system may have a port, situated anywhere along the sheet that provides fluid communication between opposing surfaces of the sheet. The port may be provided so as to allow for air to be added or removed from the isolation system. In some cases the port may be effective for maintaining or controlling a pressure state internal to the isolation system relative to the surroundings after the isolation system has been sealed.

The isolation system may have an integrated pump in connection with one way valves and/or channels generally arranged into one or more sheets of the isolation system. The pump may be a manually operated pump, whereby a user can depress the pump and it will return to an original shape. Thus the manually operated pump can be used to evacuate or add air from or to the interior of the isolation system. The valves or channels are generally arranged to provide fluid flow in a single direction between the pump and the inner surface of the sheet, or between the pump and the outer surface of the sheet. The system may have a pump and two valves and/or channels. In this case a first valve or channel may provide one way fluid communication from the interior of the isolation system to the pump, while a second valve or channel may provide one way fluid communication from the pump to the surroundings. In this arrangement, the pump may be used to remove air from the interior of the isolation system. Oppositely arranged valves and/or channels may be used to add air to the interior of the isolation system.

Alternatively, the pump may be an electromechanical pump, such as a disposable active material pump or an electromagnetically operated pump. In addition, the isolation system may have further components such as a power source, and optionally a sensor and/or a control switch for actively pumping air to or from the isolation system. In this sense, the pump may automatically add or remove fluid from the isolation system to maintain a desirable internal operating pressure during use.

In an alternative embodiment, a compact design of the isolation system may have both a pump and tear able tabs, which may be coincident with each other on or as an extension of at least one sheet of the isolation system.

Alternatively the invention provides a method for isolating a mobile computing device from an environment. The method generally includes, placing a mobile computing device into a pouch which has at least one sealable region, and further including applying pressure, heat, light and/or moisture to the sealable region so as to seal the pouch thus rendering the mobile computing device isolated from the environment.

The method may further include removing air from within the pouch prior to applying pressure to the sealable region. This can be very useful for form fitting and creating an intimate contact between the isolation system and an enclosed mobile computing device.

Alternatively the invention provides a method for isolating a mobile computing device from an environment the method including placing a mobile computing device into a pouch and sealing the pouch.

The method may further include removing or adding air from or to the pouch prior to sealing the pouch. Removal of air can be useful for creating a tight fit between the isolation system and an enclosed mobile computing device. Alternatively addition of air may be useful for padding the isolation system and thus protecting the enclosed mobile computing device from impacts. In one embodiment, the isolation system may have two layers located to one side of an enclosed mobile computing device, and air may be added between these layers.

Alternatively the invention provides a method for preparing a mobile computing device for use in a sterile environment, including placing the mobile computing device into a pouch, sealing the pouch, and sterilizing the pouch.

The method may further include placing the sealed pouch into a permeable bag prior to sterilization.

The method may include removing or adding air from or to the pouch. Air may be added or removed from the pouch before or after sealing the pouch. In the case of air removal before sealing the pouch, air may be removed though a region where the seal is made. It is also conceived that air may be added or removed through a port, which may be embedded anywhere along the pouch of the mobile computing device.

Alternatively the invention provides a method for removing a mobile computing device from a soiled pouch, the pouch having a pair of pull tabs attached to the pouch, the method including gripping the pair of pull tabs and pulling on the pull tabs so as to tear the pouch, thus exposing the mobile computing device without it getting soiled.

Alternatively the invention provides an isolation system for isolating a mobile computing device from an environment comprising a heat sealable pouch sized so as to accept a mobile computing device.

Alternatively the invention provides an isolation system for isolating a mobile computing device from an environment comprising a vacuum heat sealable pouch sized so as to accept a mobile computing device.

Alternatively the invention provides an isolation system for isolating a mobile computing device from an environment comprising a hermetically sealable pouch sized so as to form fit to a mobile computing device.

Alternatively the invention provides a hermetically sealed mobile computing device. The hermetically sealed mobile computing device may have a wipe down safe outer surface.

Alternatively the invention provides a method for hermetically sealing a mobile computing device having an outer surface, the method including applying a transparent coating over the outer surface of a mobile computing device. The transparent coating may be applied via dipping, spraying, or similar method.

Although features believed to be of importance are highlighted herein and in the appended claims, protection is sought for any novel feature or idea described herein and/or illustrated in the drawings whether or not emphasis has been placed thereon.

### BRIEF DESCRIPTION OF THE DRAWINGS

FIG. 1a—Shows an isolation system for protecting a mobile computing device. The isolation system is shown with tear-able tabs for rapid removal of an enclosed mobile computing device.

FIG. 1b—Shows an isolation system with an enclosed mobile computing device, the isolation system is optionally vacuum sealable. An optional port is also shown for providing fluid communication between the inside of the isolation system and the surrounding environment.

FIG. 2a—Shows a cross section of an isolation system with pre-sealed regions.

FIG. 2b—Shows a cross section of an alternative embodiment of an isolation system with a form fitted shape.

FIG. 2c—Shows the construction of a multilayered sheet suitable for use in an embodiment of an isolation system.

FIG. 3a—Shows an alternative embodiment of an isolation system comprising a padded layer for providing impact resistance and/or buoyancy to an enclosed mobile computing device.

FIG. 3b—Shows an alternative embodiment of an isolation system with padded regions for providing impact resistance and/or buoyancy to an enclosed mobile computing device.

FIG. 4a—Shows an embodiment of an isolation system comprising an internally positioned protrusion, the protrusion designed so as to maintain and/or enhance audio output from an encased mobile computing device.

FIG. 4b—Shows an alternative embodiment of an isolation system with an internally positioned protrusion and an enclosed mobile computing device (for reference), the isolation system being placed in a vacuum sealed condition.

FIG. 4c—Shows an isolation system comprising a dome-like protrusion used to maintain and/or improve audio output from an enclosed mobile computing device.

FIG. 5—Outlines a method for isolating a mobile computing device using an isolation system.

FIG. 6a—Shows an isolation system with a micro-spacer layer positioned above where a touch sensitive area would be located on an encased mobile computing device.

FIG. 6b—Demonstrates a close up of one embodiment of a micro-spacer layer suitable for maintaining touch functionality of an enclosed mobile computing device in an aqueous or condensing environment.

FIG. 7a—Shows an Isolation system comprising a pump and valves for evacuating air from the isolation system after enclosing a mobile computing device.

FIG. 7b—Shows an alternative embodiment of an isolation system wherein a pump and valves are integrated along with a pair of tear-able tabs on the isolation system.

### DETAILED DESCRIPTION OF THE PREFERRED EMBODIMENTS

The embodiments discussed herein are merely illustrative of specific manners in which to make and use the invention and are not to be interpreted as limiting the scope of the instant invention.

While the invention has been described with a certain degree of particularity, it is to be noted that many modifications may be made in the details of the invention's construction and the arrangement of its components without departing from the spirit and scope of this disclosure. It is understood that the invention is not limited to the embodiments set forth herein for purposes of exemplification.

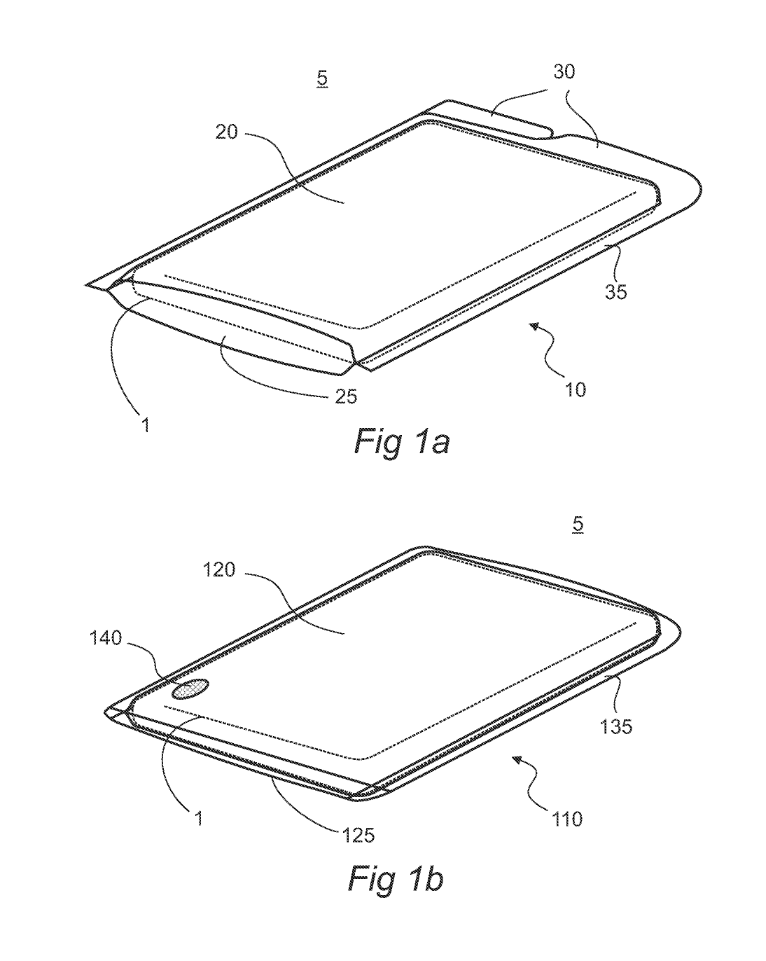

FIG. 1a illustrates an embodiment of an isolation system 10. For reference, a mobile computing device 1 is shown as it would be placed into an isolation system 10 prior to the isolation system 10 being sealed. The isolation system 10 generally comprises a sheet 20. In FIG. 1a the isolation system 10 comprises two sheets 20 but only one sheet is shown. The sheets 20 are generally arranged so as to form a pouch like shape suitable for accepting a mobile computing device 1. The isolation system 10 may further comprise a pre-sealed region 35. The pre-sealed region 35 may be an extension of the sheet 20 or it may comprise an additional layer of material that is attached to the sheet 20. The pre-sealed region 35 is generally arranged so as to provide form and shape to the isolation system 10.

The pre-sealed region 25 is generally bonded to itself, to the sheet 25 or to another pre-sealed region 25 so as to form an edge of the isolation system 10. The pre-sealed region 25 may be a heat, RF or ultrasound weld-able material or the like. In addition the pre-sealed region 25 may comprise an adhesive, a pressure sensitive adhesive, a UV curable adhesive, or similar. In one embodiment, the pre-sealed region 25 generally provides an air tight connection around a portion of the outer edge of the isolation system 10 after being sealed.

In another embodiment, the pre-sealed region 25 comprises a sealant material with well controlled bond strength. In this case, the pre-sealed region 25 may be reliably torn apart after use to open the isolation system 10 and remove an encased mobile computing device 1.

The isolation system 10 may also comprise a sealable region 25. The sealable region 25 is generally provided in an unsealed, open form, an often provides an opening for the isolation system 10 into which a mobile computing device 1 can be inserted prior to sealing. The sealable region 25 may comprise a heat, RF, or ultrasonically weld-able material, such as polyethylene, EVA, or polyester or the like. In this case, the sealable region 25 may be sealed with the appropriate welding machine. In general, the sealable region 25 is sealed by application of a combination of pressure and/or heat. The welding machine may be a stand alone machine, a vacuum sealing welder, or a hand held welder (possibly with vacuum sealing capability). After sealing, the isolation system 10 generally isolates an enclosed mobile computing device 1 from a surrounding environment 5.

The sealable region 25 may also comprise an adhesive layer (protected in some embodiments by a release liner), a pressure sensitive adhesive, a self bonding microtextured repositionable adhesive, a mechanically interlocking connector, hook and loop interlocking members, or an alternative means for creating a seal. In one embodiment, the sealable region 25 may also comprises a b-staged light sensitive material, such that after forming a seal with the sealable region 25, the strength of the seal can be increased by exposing the region to ambient light. In yet another embodiment, the sealable region 25 may be formed from a repositionable pressure sensitive adhesive such a silicone or acrylic pressure sensitive adhesive. In this embodiment, it would be possible to expose a region of an enclosed mobile computing device 1 to access a mechanical connector, so as to, for example, recharge the mobile computing device 1.

The isolation system 10 also optionally comprises one or more tear away tabs 30. The tear away tabs 30 are generally arranged as extensions of, or are attached to the sheet 20. They are generally located towards an edge of the isolation system 10 but may be located elsewhere in alternative embodiments. The tear away tabs 30 are generally provided with easily gripped textured surfaces so as to be easily grasped and pulled by a user. To achieve this functionality, the tear away tabs 30 may be coated with a soft elastic material generally with moderately tacky surface. In one embodiment, the tear away tabs 30 may compromise a textured surface formed from a thermoplastic elastomer layer, such as polyurethane or a polystyrene isoprene block copolymer. In another embodiment, the tear away tabs 30 are arranged with highly textured surfaces, so as to make them easy to grasp by a user.

The sheet 20 is generally comprised of a chemically resistant material with high optical transparency. In many cases, for a mobile computing device 1 with a capacitive touch sensitive interface, the sheet 20 should generally be an electrically isolating material. Furthermore, the sheet 20, should in general, not be overly thick so as to impede the touch functionality of an enclosed mobile computing device 1. In this sense, the sheet 20 may be generally thinner than 200 um, 100 um or 50 um. It is understood that the particular optimal thickness of the sheet 20 is a balance between rigidity, chemical resistance and preservation of touch functionality in use. In one embodiment, the sheet 20 may be comprised of polyester. In another embodiment, the sheet 20 may be comprised of a material selected from the list of PEN, polyamide, polyethylene, polypropylene and the like. Further aspects of the sheet 20 are discussed later in this disclosure.

In the case of a non-conducting sheet 20, in addition to the thickness of the sheet 20, the dielectric permittivity of the sheet may be important for maintaining the touch functionality of an enclosed mobile computing device 1. In this case, it may be beneficial for the sheet 20 to have a dielectric permittivity of less than 20, less than 5 or less than 3.

In an alternative embodiment to that shown in FIG. 1, an isolation system 10 may comprise a single sheet 20. In this case, the isolation system 10 may be form fitted to an associated mobile computing device 1. In one embodiment, the isolation system 10 may comprise a seamless sheet 20, thus providing a potentially more attractive design for the user.

The isolation system 10 can comprise a stiffened region (not shown in the figures). The stiffened region is generally placed over a button location on an associated mobile computing device 1. The stiffened region increases the force needed to engage a button over which it is located. This is useful for an embodiment of an isolation system 10 suitable for use with children. In this case, the increased force needed to push the button can be used to keep children from exiting applications and otherwise deviating from the application as desired by a supervising adult.

FIG. 1b shows an alternative embodiment of an isolation system 110 in a fully sealed configuration. In this case, the isolation system 110 is shown as it would separate an enclosed mobile computing device 1 from a surrounding environment 5. The isolation system still comprises a sheet 120, a pre-sealed region 135 and a sealable region 125. As shown in the figure, the sealable region 125 has all ready been sealed so as to encase a mobile computing device 1. The mobile computing device 1 is shown for clarity and to demonstrate how an isolation system 110 may be used in practice. In this case, the isolation system 110 has been evacuated of air prior to being sealed via application of pressure and/or heat to the sealable region 125.

Evacuation of air can be achieved by using a vacuum sealing device to draw air from the isolation system 110, generally through the sealable region 125, prior to the application of heat and/or pressure to the sealable region 125 to seal the isolation system 110.

An optional port 140 is also shown. As shown the port 140 is a feature on the sheet 120. The port 140 may also be added to the sheet 120 during the assembly process. The port 140 may be a self-sealing valve, a one-way valve, a septum seal or the like. In general, the port 140 may provide a means for adding or removing air to or from the isolation system 110 after it has been sealed. In this case, an external vacuum source, pump or syringe may be used to exchange fluid between the interior of the isolation system 110 and the surrounding environment 5 thus maintaining an internal pressure or fluid state as desired for the given application. Addition or removal of fluid from the isolation system may also be useful for achieving a tight wrinkle free fit between the sheet 120 of the isolation system 110 and an enclosed mobile computing device 1.

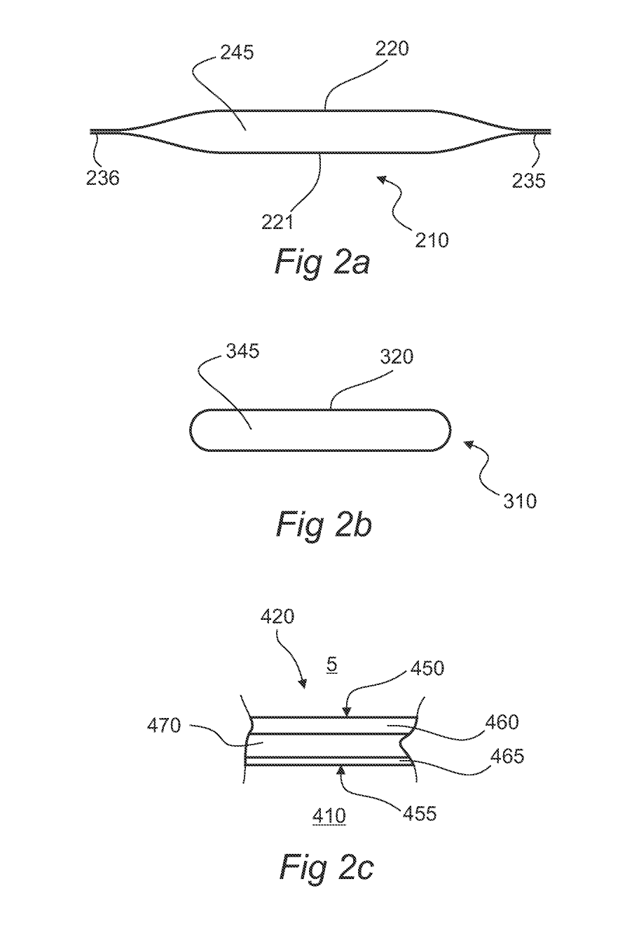

FIG. 2a shows a schematic representation of the cross section of an isolation system 210. Along the cross section as shown, the isolation system 210 comprises two sheets 220, 221 and two pre-sealed regions 235, 236. As shown in the figure, the sheets 220, 221 are bonded together along their edges through the pre-sealed regions 235, 236. Thus the isolation system 210 is formed into the shape of a pouch 245.

FIG. 2b shows a schematic representation of the cross section of an alterative embodiment of an isolation system 310. In this embodiment, along the cross section as shown, a single sheet 320 can be used to form a pouch 345. This embodiment may be preferred as being more form fitting to an enclosed mobile computing device 1, thus providing a smooth perimeter, while generally decreasing the profile of an isolated device for easy placement into a suitable holder or outer case.

FIG. 2c shows a sheet 420 of an embodiment of an isolation system 410, the sheet 420 comprised of multiple layers. An outermost layer 460, innermost layer 465 and a core layer 470 are shown. In addition the outer surface 450 and inner surface 455 are shown for clarity. Although only one core layer 470 is shown, it is understood that several core layers 470 may be included in the sheet 420. It is understood that the outer surface 450 is oriented towards the surrounding environment 5 while the inner surface 455 is oriented towards the interior of the isolation system 410. In general, the materials used to form the layers 460, 465, 470 may be chosen so as to improve the functionality of the isolation system 410.

The following discussion is directed particularly to FIG. 2c but may be applicable to the sheet 20, 120, 220, 320, 420, 520, 620, 720, 820, 920, 1020, 1120 of any of the embodiments shown as well as pertains to general discussion regarding the properties of the sheet 20, 120, 220, 320, 420, 520, 620, 720, 820, 920, 1020, 1120 suitable for a range of useful applications.

The outermost layer 460 may be formed from an anti-glare material or structure, an anti-stiction material, an oleophobic material, a barrier material, a lubricious material, a sterilizable material, a washable material, a bioresistant material, an antibacterial material, a chemically resistant material and/or any combination thereof. In an alternative embodiment, the outermost layer 460 offers mechanical protection, preferably scratch protection. In particular embodiments, the outermost layer 460 may provide protection against the spread of bacteria in medical and multi-user applications.

The innermost layer 465 may be a barrier material, a lubricious material, a sterilizable material, a high clarity material, an optical filter material, and/or any combination thereof. In general, the innermost layer 465 may provide optical filtering capability, and/or a smooth interface against an enclosed mobile computing device 1.

Suitable optical filtering capability includes polarized functions, a lenticularly oriented function, a dithering function, a shaded function, or a UV blocking function.

Any of the layers 460, 465, 470, particularly the outermost layer 460 or the innermost layer 465 may be textured so as to further enhance functionality of the isolation system 410. Texturing and microtexturing of layers 460, 465, 470 may be used to enhance oleophobic properties, maintain touch functionality in soiled or aqueous environments, provide optical filtering functions to the sheet 420.

As well as being comprised of materials as listed above, the core layer 470 may be comprised of a structural layer, an optical filter, or the like. Although the core layer 470 may provide many of the functionalities listed above, in general, the core layer 470 may provide structural support for the sheet 420.

In general all layers 460, 465, 470 may be transparent although in some cases semi transparent or opaque layers 460, 465, 470 or regions thereof may be preferred for decoration and/or outdoor filtering or the like.

In other applications where the mobile computing device 1 is intended for use among multiple users, or in public settings, the isolation system 410 may be washable with a cleaning agent such as isopropyl alcohol. In this case, the sheet 420 or the outermost layer 460 of the sheet 420 may be comprised of a suitably resistant material such as polyethylene, polypropylene or polyester (PET).

In addition, a single layered sheet 420 may also comprise any of one, or any combination of the above materials, but the preferred function can often be achieved using a sheet 420 comprising multiple layers 460, 465, 470.

Multiple layers 460, 465, 470 of a sheet 420 may be formed by coating methods, such as roller coating, dipping, printing, and the like. In addition, two or more layers 460, 465, 470 maybe laminated together to form a multi-layered sheet 420.

A structural material is a material that adds structural support to the sheet 20, 120, 220, 320, 420, 520, 620, 720, 820, 920, 1020, 1120 and is generally selected from a biaxially oriented polypropylene (OPP), polyester (PET), biaxially oriented nylon (OPA) biaxially oriented polyethylene naphthalate (PEN) and similar materials.

An anti-glare material or structure reduces the amount of light reflected off of the isolation system 10, 110, 210, 310, 410, 510, 610, 710, 810, 910, 1010, 1110. In one case, an anti-glare material may have a matt finished surface, while in other cases it may be formed from low reflectance coating. Such coatings are described in US20090499093 Sung et al., Optical Film and Method of Making the Same, U.S. application Ser. No. 12/499,093. Another example of an anti-glare coating is provided by US20080250563 Liu et al., Bottom Antireflective coating compositions, U.S. application Ser. No. 12/250,563.

By anti-stiction or lubricious material is meant a material with a relatively low coefficient of friction. An anti-stiction or lubricious material may be a fluoropolymer such as polytetrafluoroethylene (PTFE), perfluoroalkoxy polymer resin (PFA), fluorinated ethylene-propylene (FEP), polyethylenetetrafluoroethylene (ETFE), polyvinylfluoride (PVF), polyethylenechlorotrifluoroethylene (ECTFE), polyvinylidene fluoride (PVDF), polychlorotrifluoroethylene (PCTFE), perfluoropolyether (PFPE), and Nafion amongst others.

By oleophobic material is meant a material that is generally repellant to oil and water. Oleophobic materials include fluorinated, hydrophobic, poly-hedral oligomeric silsesquioxane molecules with a moderately hydrophilic polymer such as polymethyl methacrylate (PMMA), FTFE, or combinations thereof. Generally, such hydrophobic materials are textured with characteristic length scales over several orders of magnitude to produce super hydrophobic and/or super oleophobic materials.

A barrier material has relatively low permeability to gases, in particular water vapor. Some suitable materials and coatings include polyimide and oriented polyimide, PVDC, nano ceramic platelet coated PET (i.e. nano alumina platelet coated PET), SiOx, EVOH or OPA, or combinations thereof.

By sterilizable material is meant a material that can be effectively sterilized and withstand sterilization from one or more commonly used sterilization methods such as e-beam sterilization, steam, ozone, chemical disinfectants, among others. Some suitable sterilizable materials include polypropylene, polymethylpentene, polypropylene copolymer, TEFZEL ETFE, TEFLON FEP, polyolefins, polyesters, polyacrylates, polyalkylacrylates, peek, polyamide, polyacetals, and PFA, as well as polycarbonate, or combinations thereof.

By washable material is meant a material that can be washed using a common cleaning solvent such as isopropanol. Some examples of such materials are polypropylene, polyester, polycarbonate, and polyurethane, or combinations thereof.

By bioresistant material is meant a material to prevent or reduce bacterial adhesion and growth there upon. Bioresistant materials generally show low bioactivity. In one embodiment, the bioresistant material may be formed from a self-assembled monolayer of phosphate, such as Orthobond available from Orthobond Corporation. Other bioresistant materials that may be suitable include thin continuous or broken layers of include titanium, nickel alloys, and PEEK or combinations thereof. Furthermore, transparent bioresistant materials may be formed from a polymer that contains an antimicrobial, bioresistant and fungal resistant moiety that is linked into the backbone of the polymer. Some suitable moieties may include a bromine atom and a nitro group linked to one or more of the carbon atoms forming the backbone of the polymer.

By antibacterial material is meant a material that is suitable of killing bacteria that come into contact with it. There are a wide range of such materials that are suitable for use in an isolation system. Some particular materials include composites comprising Ag-ION particles, TiO2 particles, and polymeric materials, or laminates thereof.

By chemically resistant material is meant a material that can tolerate chemicals generally found in a particular operating environment 5. In the case of oil resistance, suitable materials include chlorinated polyethylene, chlorosulfonated polyethylene, acrylates, silicones, fluorosilicones, fluorocarbons and polyurethanes or combinations thereof. Other material choices may be more suitable for particular environmental use such as laboratories, kitchens and the like.

By high clarity material is meant a material with high optical transmission in the visual range as well as low haze properties. High clarity materials include polyester, polyimide, polyethylene terephthalate (PET), Polyethylene naphthalate (PEN), or the like.

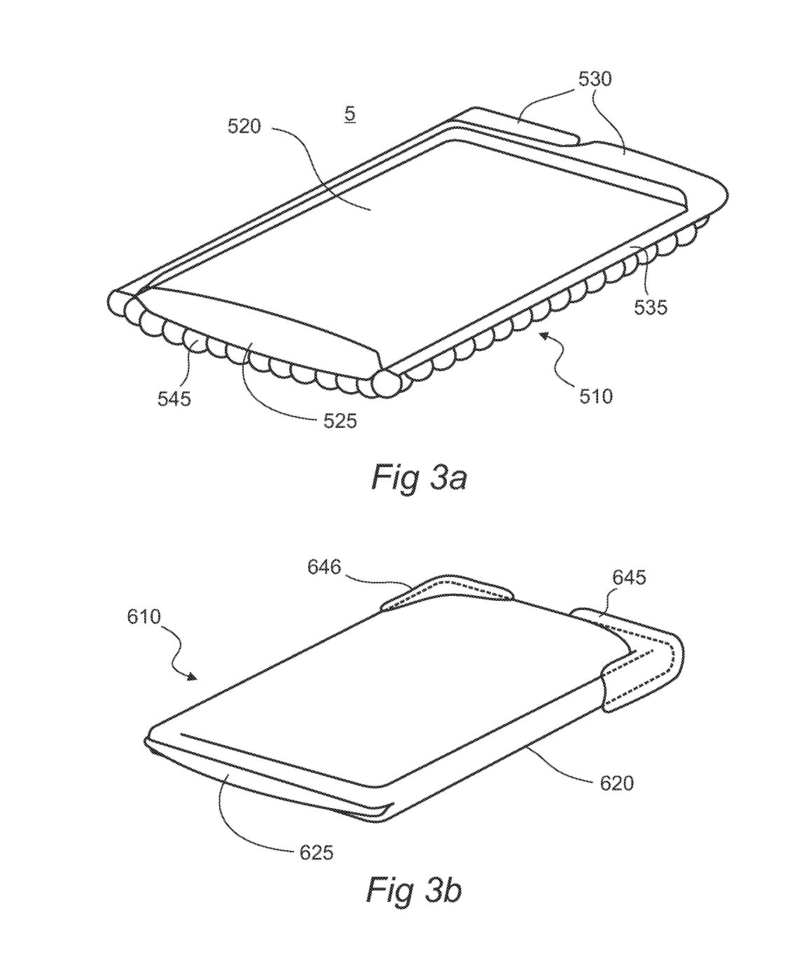

FIG. 3a shows an embodiment of an isolation system 510 comprising a sheet 520, a sealable region 525, a pre-sealed region 535 and tear-able tabs 530. The isolation system 510 further comprises a padded layer 545. In the case of a sheet 520 comprising multiple layers, the padded layer 545 may be selected as an outermost layer in a multilayered sheet 520. The padded layer 545 generally comprises an open or closed cell foam or filled bladders or balloons. The padded layer 545 may also comprise a polyurethane gel, silicone gel, hydrogel or the like.

In the case that the padded layer 545 is comprised of filled bladders or balloons, the bladders may be filled with a fluid such as air, liquid, a gel or the like.

In general the padded layer 545 may provide impact resistance for the isolation system 510. In addition, in the case of closed cell foam alternatives as well as air filled bladders or balloons can provide buoyancy to the isolation system 510.

FIG. 3b shows an alternative isolation system 610 comprising a sheet 620, a sealable region 625 (shown in a sealed configuration) and padded regions 645, 646. In this case the padded regions 645, 646 may be applied only onto a portion of a sheet 620. The padded region 645, 646 may be comprised of the same materials as the padded layer 545 described earlier. In one embodiment the padded region 645, 646 may be closed cell foam. In another embodiment a padded region 645, 646 may comprise a single air or gel filled bladder. In this case the padded region 645, 646 may be strategically located on the isolation system 610 to maximize impact resistance while minimizing material usage.

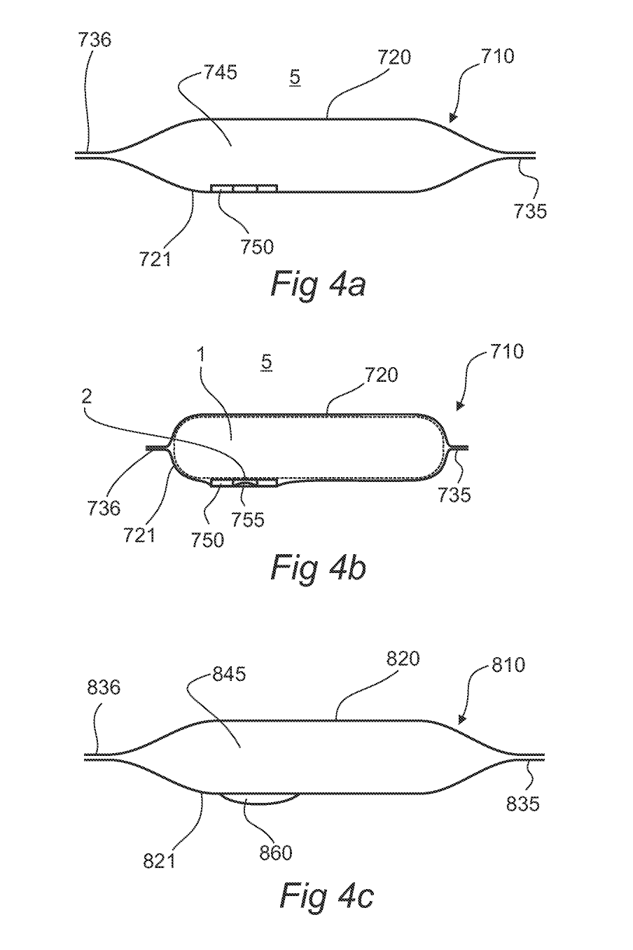

FIG. 4a shows a schematic cross section of an alternative embodiment for an isolation system 710. In this embodiment, the isolation system 710 comprises multiple sheets 720, 721 with pre-sealed regions 735, 736 generally arranged to form a pouch 745. The isolation system 710 further comprises a shaped protrusion 750. The shaped protrusion 750 is generally located around a peripheral component of a particular mobile computing device 1 (not shown). The peripheral component may be a speaker outlet, a button, a camera lens, a connector or the like.

The shaped protrusion 750 may face towards the interior of the pouch 745 but it may also face outwardly towards the surrounding environment 5. The shaped protrusion 750 may be formed from foam, polymer, gel, or the like. In addition, the shaped protrusion 750 may be thermoformed from the sheet 720. In this case, the sheet 720 is a polymer layer such as PET that can be thermoformed during processing.

The shaped protrusion 750 may take the shape of a washer, an ellipse or similar. The shaped protrusion 750 may also have a highly stylized shape such a company logo, a character, or the like.

FIG. 4b shows the isolation system 710 of FIG. 4a in an alternative configuration. In this case, the isolation system 710 is shown with an encased mobile computing device 1. In addition, the isolation system 710 as shown has been vacuum sealed so as to form a tight, wrinkle free fit against an enclosed mobile computing device 1. As in previous examples, the isolation system 710 is arranged so as to isolate the enclosed mobile computing device 1 from the surrounding environment 5. The location of the peripheral component 2 on the mobile computing device 1 is shown for reference. In this case, the peripheral component 2 is a speaker outlet. As shown, the shaped protrusion 750 is collocated with the peripheral component 2. After application of a vacuum, a concave membrane 755 is formed within an open area of the shaped protrusion 750. The concave membrane 755 can be used to enhance the audio output from the enclosed mobile computing device 1.

In a particular embodiment, the shaped protrusion 750 is useful for preserving or enhancing the audio output from an enclosed mobile computing device 1. The shaped protrusion 750 creates a void between the sheet 720 and an enclosed mobile computing device 1 in the vicinity of the peripheral component 2. This void can be used as an acoustic filter, to create an air volume around the peripheral component 2, in this case a speaker, of the mobile computing device 1.

In an alternative embodiment, the shaped protrusion 750 maybe used to enhance the optical filter of an enclosed camera. In this case, the peripheral component 2 may be a camera of an enclosed mobile computing device 1. In this case, the shaped protrusion 750 acts as a lens to improve the optical match between the camera and the surrounding environment 5.

FIG. 4c shows yet another embodiment of an isolation system 810. The isolation system 810 comprises sheets 820 in contact with pre-sealed regions 835, 836. The isolation system 810 is arranged in the form of a pouch 845. In addition, the isolation system 810 comprises a dome-like protrusion 860. The dome-like protrusion 860 is generally collocated with the peripheral component 2 of an enclosed mobile computing device 1 which is not shown in the figure. In one case, the peripheral component 2 may be a speaker. The dome-like protrusion 860 may be attached to, or be an extension of the sheet 820. The dome-like protrusion 860 generally extends out from the isolation system 810. The dome-like protrusion 860 may be thermoformed from the sheet 820. In an alternative embodiment, the dome-like protrusion 860 may be formed from a separate plastic component such as a dome with high acoustic quality and attached to the sheet 820.

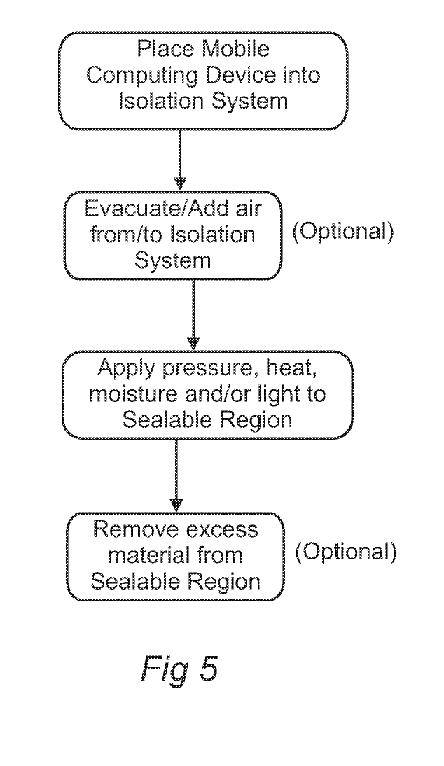

FIG. 5 shows a method for isolating a mobile computing device 1 from a surrounding environment 5. The method comprises, placing a mobile computing device 1 into an isolation system 10, 110, 210, 310, 410, 510, 610, 710, 810, 910, 1010, 1110. The method may optionally comprise evacuating or adding air from or to the isolation system 10, 110, 210, 310, 410, 510, 610, 710, 810, 910, 1010, 1110. The method may further comprise applying pressure, heat, moisture and/or light to a sealable region 25, 125, 525, 625, 925, 1125 of the isolation system 10, 110, 210, 310, 410, 510, 610, 710, 810, 910, 1010, 1110. In this way, the isolation system 10, 110, 210, 310, 410, 510, 610, 710, 810, 910, 1010, 1110 becomes sealed so as to prevent fluid exchange between the enclosed mobile computing device 1 and the surrounding environment 5.

The method may also optionally comprise removing excess material from the sealable region 25, 125, 525, 625, 925, 1125. This is generally done when excess material is present after the sealing operation is completed. It can be useful to create a more compact, less intrusive isolation system 10, 110, 210, 310, 410, 510, 610, 710, 810, 910, 1010, 1110. Removal of excess material can be generally achieved with a knife, scissors or similar instrument.

The sealable region 25, 125, 525, 625, 925, 1125 may comprise a foldable region and adhesive such that the sealable region 25, 125, 525, 625, 925, 1125 may be folded or rolled over the adjacent sheet 20, 120, 220, 320, 420, 520, 620, 720, 820, 920, 1020, 1120 to seal the isolation system 10, 110, 210, 310, 410, 510, 610, 710, 810, 910, 1010, 1110 thus enclosing a mobile computing device 1 and isolating it from the surrounding environment 5.

A method for preparing a mobile computing device 1 for use in a sterile operating theater is disclosed. The method comprises the above steps as described in FIG. 5, with the additional step of sterilizing the isolation system 10, 110, 210, 310, 410, 510, 610, 710, 810, 910, 1010, 1110 along with the encased mobile computing device 1. To achieve the step of sterilization, the isolation system 10, 110, 210, 310, 410, 510, 610, 710, 810, 910, 1010, 1110 and encased mobile computing device 1 may be placed into a sterilization bag and sterilized using known sterilization procedures. One particular sterilization procedure may be EtO sterilization. Alternative sterilization methods may include e-beam sterilization, steam, ozone, chemical disinfectants, among others.

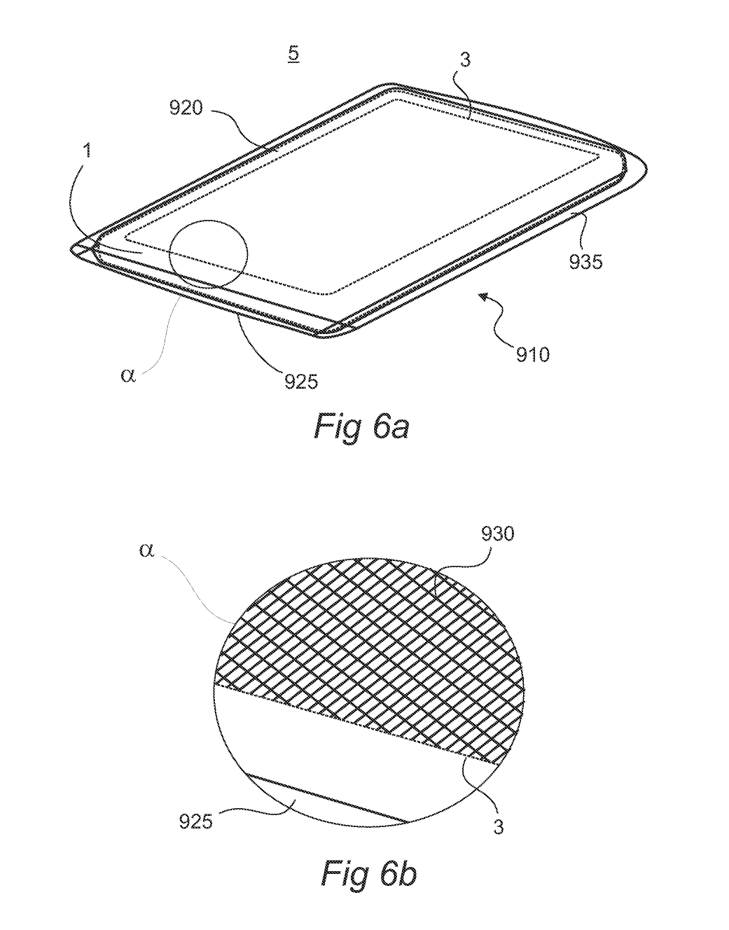

FIG. 6a shows an embodiment of an isolation system 910 for sealing a mobile computing device 1, which has a touch sensitive area 3 from a surrounding environment 5. The isolation system 910 may comprise a sheet 920, a pre-sealed region 935 and a sealable region 925 (shown in a sealed condition). A highlighted region α, is shown in the figure. The sheet 920 has a feature to be arranged over the touch sensitive area 3 of an encased mobile computing device 1.

FIG. 6b shows the highlighted region α from the embodiment of the isolation system 910 shown in FIG. 6a. The highlighted region α shows the sealable region 925 and the touch sensitive area 3 from FIG. 6a. In addition, a microspacer layer 930 is shown as collocated over the touch sensitive area 3. The microspacer layer 930 is formed so as to create a gap over the touch sensitive area 3 of the mobile computing device 1. The microspacer layer 930 is generally formed from a pattern of spaced ribs between evacuated cells. The spaced ribs may have pores or channels so as to interconnect adjacent cells. The microspacer layer 930 comprising the spaced ribs may be thicker than 0.5 mm, thicker than 1 mm or thicker than 1.5 mm. The cells generally a have a thin outer layer, the layer being less than 200 um thick, less than 100 um thick or less than 50 um thick. The microspacer layer 930 is generally transparent so that the user can still see the screen of the mobile computing device 1.

The cells of the microspacer layer 930 can be collapsed when a user pushes against them, thus locally reducing the distance between the touch sensitive area 3 and the user (as well as the surrounding environment 5). Thus touch sensitivity of the mobile computing device 1 may be preserved even in electrically conducting environments such as aqueous environments and high humidity, condensing environments. The touch sensitivity may also be preserved when the isolation system 910 is soiled during use. Such can be the case in an operating theater if the isolation system 910 gets soiled with body fluids or in a situation where the isolation system 910 gets covered with food, paint, liquids or gels during use.

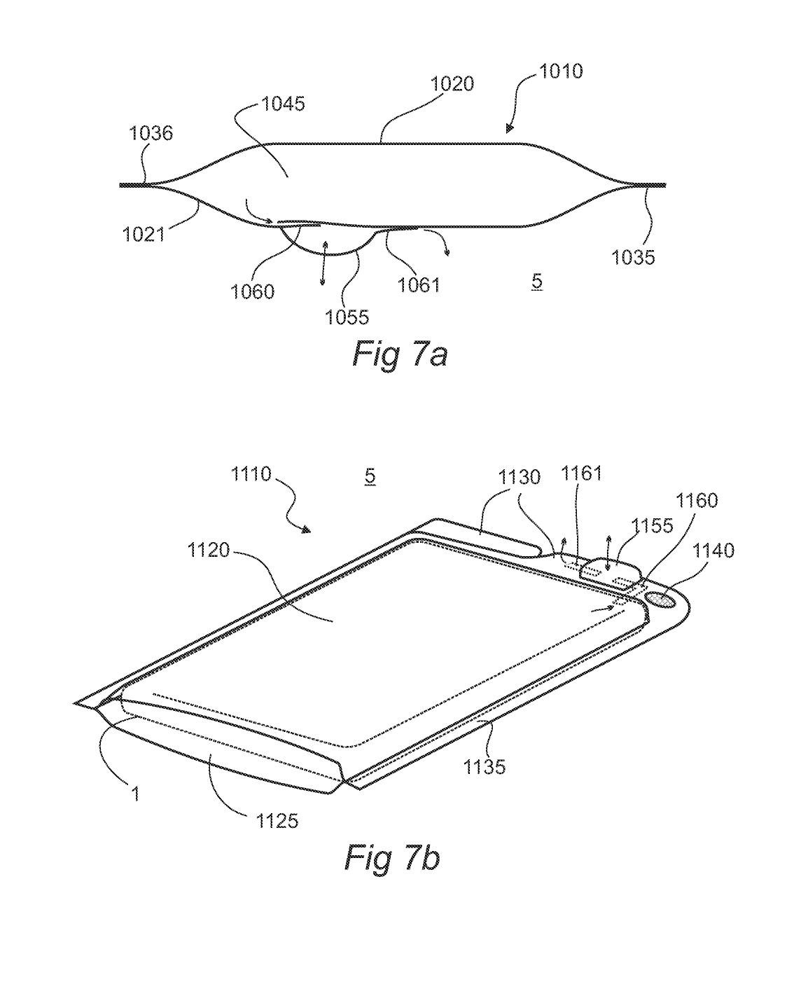

FIG. 7a shows the cross section of an isolation system 1010 comprising a means for creating a vacuum seal within the isolation system 1010. In this embodiment, the isolation system 1010 may comprise sheets 1020, 1021, pre-sealed regions 1035, 1036, the isolation system 1010 arranged so as to form a pouch 1045. In addition, the isolation system 1010 may comprise a pump 1055 and one or more check valves 1060, 1061 for exchanging air from within the pouch 1045 and the surrounding environment 5.

The pump 1055 as shown may be a flexible reservoir with a convex shape that can be pressed by a user to empty it of air. The pump 1055 may be self filling, such that after being pressed, the pump 1055 will return to its original convex shape, thus filling with air. The pump 1055 may be a soft elastomeric material or it may also be a snap dome. In another embodiment, the pump 1055 may be filled with open-celled foam to return it to its original shape after being pressed. In another embodiment, the pump 1055 may comprise a soft air tight membrane with a pull able member such that the pump 1055 may be emptied by pushing and refilled by pulling on the usable member.

The isolation system 1010 may also comprise check valves 1060, 1061 that control the flow of air to and from the pump 1055 during pressing and refilling cycles. A check valve 1060 may be arranged to control unidirectional air flow from the interior of the pouch 1045 into the pump 1055 during a refill cycle. Another check valve 1061 may be arranged to control unidirectional air flow from within the pump 1055 to the surrounding environment 5 during a push cycle. The pump 1055 and check valves 1060, 1061 may be formed from a planar process, all being an arrangement of stacked layers to form the pump and valve/channel structures. The resulting assembly may be attached to the sheet 1021. The pump 1055 may also be thermoformed from the sheet 1021. In this embodiment, the check valves 1060, 1061 may be formed into an assembly and attached to the inner surface of the sheet 1021 collocated under the pump 1055.

FIG. 7b shows an alternative embodiment of the isolation system 1110. The alternative embodiment shown may be particularly useful for a practical implementation of an isolation system 1110. In this embodiment, the isolation system 1110 comprises a pair of tear-able tabs 1130 onto which a pump 1155 and two 1-way channels 1160, 1161 are formed. In this embodiment, the 1-way channels 1160, 1161 are generally sheet based channels that behave like 1-way valves, thus controlling the direction of flow between an enclosed mobile computing device 1 and the surrounding environment 5. In one embodiment a first 1-way channel 1160 is arranged to control the direction of flow between the enclosed mobile computing device 1 and the pump 1155 and a second 1-way channel 1161 is arranged to control the direction of flow between the pump 1155 and the surrounding environment 5.

In another embodiment, the pump 1155 and 1-way channels 1160, 1161 may be electromechanical components, preferably disposable components that actively maintain the environment within the isolation system 1110. In another embodiment, the pump 1155 and 1-way channels 1160, 1161 may be built into a reusable pump assembly that can be remove-ably attached to the sheet 1120 or the tear-able tabs 1130. In this embodiment, the sheet 1120 or tear-able tabs 1130 may have preconfigured holes or passageways that can interface with the pump assembly after attachment. In one embodiment, the preconfigured holes or passageways have one way flaps to prevent air exchange through the sheet 1120 once the interior of the isolation system 1110 has been pumped to the desired pressure level by the pump assembly.

In the case of an electromechanical pump 1155, the pump 1155 may be constructed from typical technologies such as active materials, electromagnetic materials, electrostatic approaches and the like. The valves or channels 1160, 1161 may also be passive or active components. The pump 1155, valves or channels 1160, 1161 may be collectively formed into an electromechanical assembly. The electromechanical assembly may have associated electronics and battery for providing power to the pump 1155 and optionally to the valves 1160, 1161 for exchanging fluid from within the isolation system 1110 and the surrounding environment 5. In one embodiment, the electronics may include a connector for interfacing with an enclosed mobile computing device 1, thus providing a means for powering the electromechanical assembly, the pump 1155 and/or the valves or channels 1160, 1161 from the mobile computing device 1 as well as utilizing the mobile computing device 1 as an interface for a user to control the environments within the isolation system 1110. Furthermore, the pump assembly and system may comprise a pressure sensor, potentially an absolute pressure sensor, such as an altimeter. In this case, the pressure sensor may be suitable for warning a user of a breach in the isolation system 1110. In addition, some mobile computing devices 1 may be equipped with altimeters or barometers. Thus these onboard sensors can be used to determine if the seal is being maintained between the interior of the isolation system 1110 and the surrounding environment 5.

In a further embodiment, the sheet 1120 of the isolation system 1110 may comprise a port 1140. The port 1140 may be a septum seal or a one-way valve such that a user can exchange air between the interior of the isolation system 1110 and the surrounding environment 5 using an externally applied fluid source or sink. In one case, the user may use a hand held vacuum pump to evacuate air from within the isolation system 1110 through the port 1140. In another embodiment, the user may use a syringe to achieve the same goal. In yet another embodiment, the user may attach a hand operated pump so as to add or remove air to or from the isolation system 1110 via the port 1140.

It is generally understood that the embodiments shown may be altered while maintaining their viability in the intended application. For example, it is understood that an opening in the isolation system 10, 110, 210, 310, 410, 510, 610, 710, 810, 910, 1010, 1110 need not be formed along an edge. Alternatively an opening may be formed in any sensible location along the isolation system 10, 110, 210, 310, 410, 510, 610, 710, 810, 910, 1010, 1110. It is also understood that the seams formed by pre-sealed region 35, 135, 235, 535, 735, 736, 835, 836, 935, 1035, 1036, 1135 may be formed on the inside of the pouch 245, 745, 845, 1045 or located away from the edge of the pouch 245, 745, 845, 1045.

It will be appreciated that additional advantages and modifications will readily occur to those skilled in the art. Therefore, the invention and its broader aspects are not limited to the specific details and representative embodiments shown and described herein. Accordingly, many modifications, equivalents, and improvements may be included without departing from the spirit or scope of the general inventive concept as defined by the appended claims and their equivalents.

What is claimed is:

1. An isolation system for isolating a mobile computing device from an environment whilst maintaining functionality thereof, comprising:
at least one sheet, the sheet comprised of at least one layer, the sheet arranged so as to form a pouch, the pouch arranged so as to have an inside surface, an outside surface, and an opening, the pouch shaped so as to accept the mobile computing device, further comprising at least one sealable region in connection with or as an extension of the at least one sheet, situated near the opening of the pouch, whereby sealing of the sealable region isolates the mobile computing device held within the isolation system from a surrounding environment whilst maintaining functionality thereof.

2. The isolation system of claim 1, wherein the sealable region comprises a heat sealable material.

3. The isolation system of claim 1, wherein the sealable region comprises an adhesive layer.

4. The isolation system of claim 1, wherein at least one layer or portion thereof is formed from a heat sealable material.

5. The isolation system of claim 1, wherein at least one layer or portion thereof is formed from an oleophobic material.

6. The isolation system of claim 1, wherein at least one layer or portion thereof is formed from a scratch or abrasion resistant material.

7. The isolation system of claim 1, wherein at least one layer or portion thereof is formed from a salt water resistant material.

8. The isolation system of claim 1, wherein at least one layer or portion thereof is formed from an antireflective or antiglare material.

9. The isolation system of claim 1, wherein the sealable region is arranged so as to provide an airtight seal when sealed.

10. The isolation system of claim 1, wherein at least one layer is a formed from a rubber like material.

11. The isolation system of claim 1, wherein at least one layer or portion thereof is formed from an antibacterial material.

12. The isolation system of claim 1, wherein at least one layer or portion thereof is formed from a bioresistant material.

13. The isolation system of claim 1, comprising at least one layer or portion thereof formed from an optically functional material selected from a polarized sheet, a lenticularly oriented sheet, a dithering sheet, a shaded sheet, or a UV blocking sheet.

14. The isolation system of claim 1, wherein the layer of the sheet that forms at least a portion of the inner surface of the pouch is formed from a heat sealable material.

15. The isolation system of claim 1, wherein the layer of the sheet that forms at least a portion of the outer surface of the pouch is formed from an oleophobic material.

16. The isolation system of claim 1, wherein the layer of the sheet that forms at least a portion of the outer surface of the pouch is formed from an antireflective or antiglare material.

17. The isolation system of claim 1, wherein at least one sheet comprises an air filled layer, whereby the air filled layer comprises an array of bladders, laminates, foams, or irregular regions encasing trapped air, whereby the air filled layer can protect the device from unexpected impacts, while also rendering the isolation system and an enclosed mobile computing device, buoyant in an aqueous environment.

18. The isolation system of claim 1, wherein at least one sheet comprises a gel layer to protect the device from unexpected impacts.

19. The isolation system of claim 1, wherein at least one layer of one sheet is formed from a sterilizable material.

20. The isolation system of claim 1, further comprising at least one pair of tear away tabs, the tear away tabs being an extension of at least one sheet or attached thereto, the tear away tabs arranged in physical contact with each other and arranged along an edge of the pouch, whereby the tear away tabs can be forcefully separated to open the isolation system and retrieve an internally held mobile computing device.

21. The isolation system of claim 1, further comprising an embossed region oriented on the interior surface of the pouch, whereby the embossed region is arranged so as to form a gap over a peripheral component of an internally held mobile computing device.

22. The isolation system of claim 1, further comprising a dome shaped region oriented so as to protrude out from the outer surface of the pouch, whereby the dome shaped region is arranged so as to form an air gap over a peripheral component of an internally held mobile computing device.

23. The isolation system of claim 1, further comprising a port situated the sheet, whereby the port provides a means for fluid communication between the interior of the isolation system and the surrounding environment.

24. The isolation system of claim 1, further comprising a pump arranged as part thereof or attached to the sheet and at least two valves or channels, the first valve or channel arranged so as to provide fluid communication between the interior of the isolation system and the pump, the second valve or channel arranged so as to provide fluid communication between the pump and the surrounding environment, the pump being arranged so as to add or remove fluid from the isolation system via the valves or channels.

25. The isolation system of claim 24, wherein the pump is an electromechanical micropump comprising active materials, electromagnetic materials, or electrostatic materials.

26. The isolation system of claim 25, wherein the isolation system further comprises a connector for interfacing the pump with the enclosed mobile computing device.

27. The isolation system of claim 1, further comprising a pressure sensor whereby the pressure sensor can be used to determine if the seal of the isolation system is compromised.

28. A method for isolating a mobile computing device from an environment whilst maintaining functionality thereof, comprising:
placing a mobile computing device into a pouch and sealing the pouch.

29. A method according to claim 28, wherein the pouch has at least one sealable region and is sealed by applying pressure, heat, light and/or moisture to the sealable region.

30. A method of claim 29, further comprising the step of sterilizing the pouch.

31. The method of claim 30, further comprising removing or adding air from or to the pouch.

32. A method for removing a mobile computing device from a soiled pouch, the pouch comprising:
a pair of pull tabs attached thereto, the method comprising gripping the pair of pull tabs and pulling on the pull tabs so as to tear the pouch, thus exposing the mobile computing device without it getting soiled.
